(19) United States
(12) Patent Application Publication
(10) Pub. No.: US 2007/0034198 A1
(43) Pub. Date: Feb. 15, 2007

(54) Portable anti-spill single gas burner camp stove

(76) Inventor: Yoel Arad, Oshrat (IL)

Correspondence Address: NATH & ASSOCIATES, 112 South West Street, Alexandria, VA, 22314, US

(21) Appl. No.: 10/558,230

(22) PCT Filed: May 19, 2004
(86) PCT No.: PCT/IL04/00428

§ 371 Date: Nov. 23, 2005

Related U.S. Application Data
(60) Provisional application No. 60/472,784, filed on May 23, 2003.

(51) Int. Cl. A47J 37/07

(52) U.S. Cl. 126/9 R

(57) ABSTRACT

The present invention is for a portable anti-spill single gas burner camp stove (1) with a housing (2) having a single gas burner (4) for selectively heating a coffeepot (6) placed thereover, and a sleeve-like anti-spill windshield (13) for snugly receiving at least a major portion of the coffeepot (6) therein on its downward sliding insertion thereinto, thereby rendering the safe and convenient preparation of hot beverages.

### FIELD OF THE INVENTION

The invention is in the field of portable camp stoves in general and portable single gas burner camp stoves in particular.

### BACKGROUND OF THE INVENTION

Portable single gas burner camp stoves are widely used during outdoor activities such as camping, picnics, and the like, and traveling for extended periods, for example, on a boat, in a train, and the like, for cooking purposes including boiling water and preparing hot beverages. Such camp stoves are often set up on surfaces which are neither flat nor stable, and used outdoor during windy weather neither condition being conducive to their safe and convenient use. Exemplary portable single gas burner camp stoves and assorted accessories therefor are illustrated and described in inter alia U.S. Pat. No. 4,105,013, U.S. Pat. No. 4,512,328, U.S. Pat. No. 4,905,659, U.S. Pat. No. 5,992,407, GB 2 380 788, GB 2 370 108, and DE 41 27 077.

### SUMMARY OF THE INVENTION

The present invention is for a portable anti-spill single gas burner camp stove including a housing with a single gas burner for selectively heating a coffeepot placed thereover, and a sleeve-like anti-spill windshield for snugly retaining at least a major portion of a coffeepot therein on its downward sliding insertion thereinto for facilitating the safe and convenient boiling of hot water for the preparation of hot beverages, the brewing of tea, and the like. The anti-spill windshield is preferably removably secured to the camp stove whereby, upon its removal, a frying pan, a saucepan and the like, can be placed over the gas burner for general cooking purposes. Moreover, an anti-spill windshield is preferably invertible mounted on the housing for doubling as a casing for rendering a compact nested camp stove for convenient storage and carrying purposes.

### BRIEF DESCRIPTION OF THE DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1 is a partially cut away pictorial view showing the use of a portable anti-spill single gas burner camp stove in accordance with one embodiment of the present invention;

FIG. 2 is an exploded view of a nested portable anti-spill single gas burner camp stove in accordance with another embodiment of the present invention;

FIG. 3 is a partially cut away pictorial view of the nested camp stove of FIG. 2; and

FIG. 4 is a partially cut away pictorial view showing the use of the camp stove of FIG. 2.

### DETAILED DESCRIPTION OF PREFERRED EMBODIMENTS OF THE PRESENT INVENTION

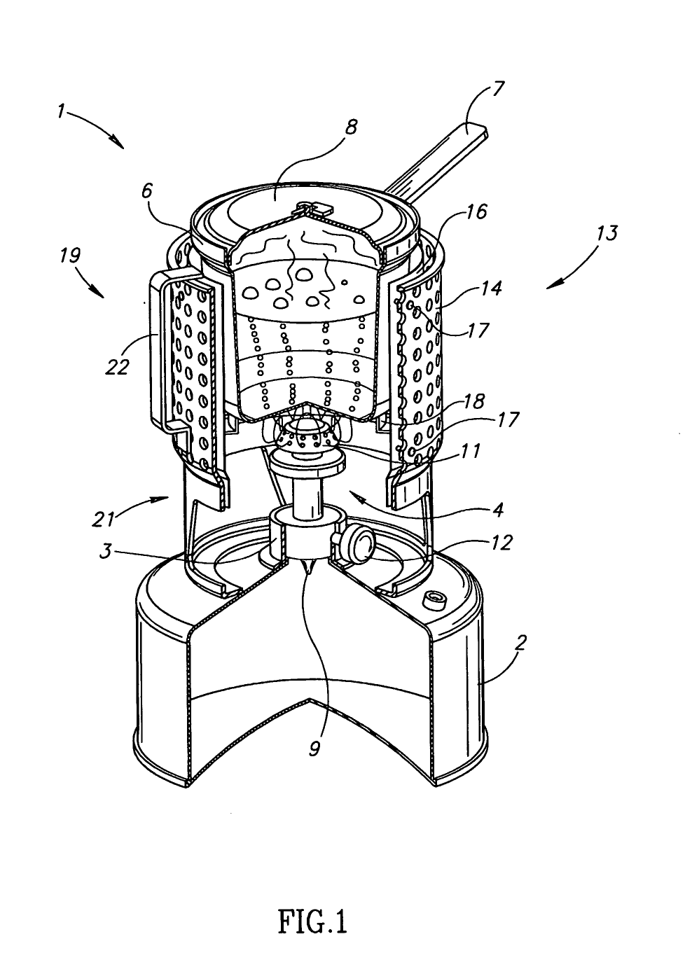

FIG. 1 shows a portable anti-spill single gas burner camp stove 1 including a refillable housing 2 containing a combustible gas supply and having a tapped bore 3 for sealingly receiving a gas burner 4 for heating a coffeepot 6 having a carrying handle 7 and a lid 8. The gas burner 4 includes a nipple 9, a burner head 11 and a manually operated valve 12 for regulating gas flow for controlling the gas burner's flame. The gas burner 9 may provided with a manually operated electronic ignition device. The camp stove I includes a sleeve-like anti-spill windshield 13 for protecting the gas burner 4 against wind and snugly retaining the coffeepot 6 therein so that it cannot be inadvertently knocked off the gas burner 4, thereby enabling the safe and convenient boiling of hot water for the preparation of hot beverages, the brewing of tea, and the like.

The anti-spill windshield 13 includes an outer heavy duty plastic material perforated jacket 14 with an inner metal lining 16 spaced therefrom by a number of spacers 17 such that the anti-spill windshield 13 can safely touched by hand even with the coffeepot 6 containing boiling contents. The lining 16 has a flange 18 for supporting the coffeepot 6 over the gas burner 4, and also acts to protect the anti-spill windshield 13 from the gas burner's flame and facilitating heat dissipation. The jacket 14 includes a windshield portion 19 dimensioned to extend upwards upto the juncture of the coffeepot 6 and its carrying handle 7 such that the anti-spill windshield 13 receives substantially the entire coffeepot 6 therein on its downward sliding insertion thereinto, and a near completely open ventilation portion 21 for preventing downward suction of the gas burner's flame during use of the camp stove 1, and providing access to the manually operated valve 12. The anti-spill windshield 13 can be optionally provided with a carrying handle 22 further facilitating safe passing of even a near full coffeepot 6 between users.

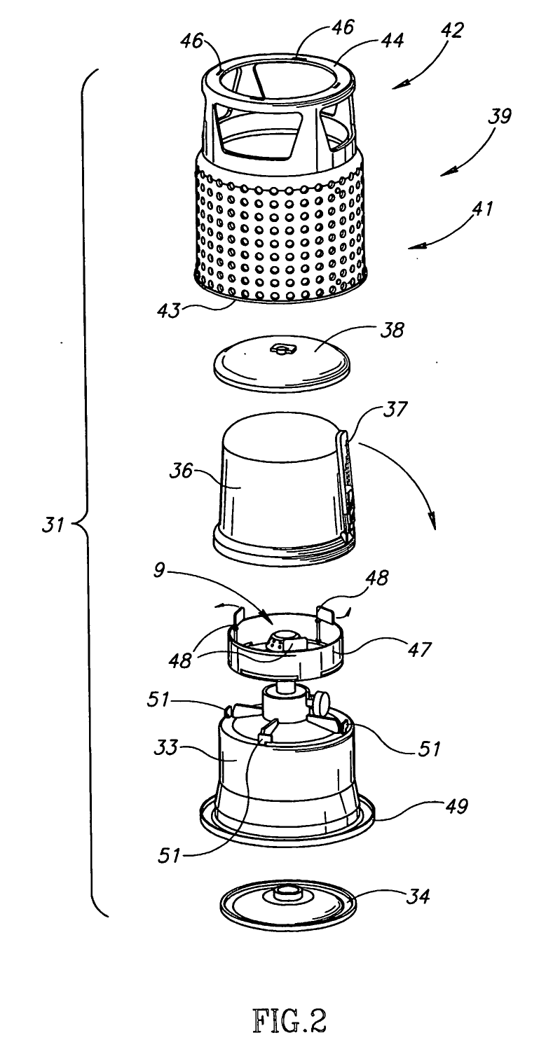

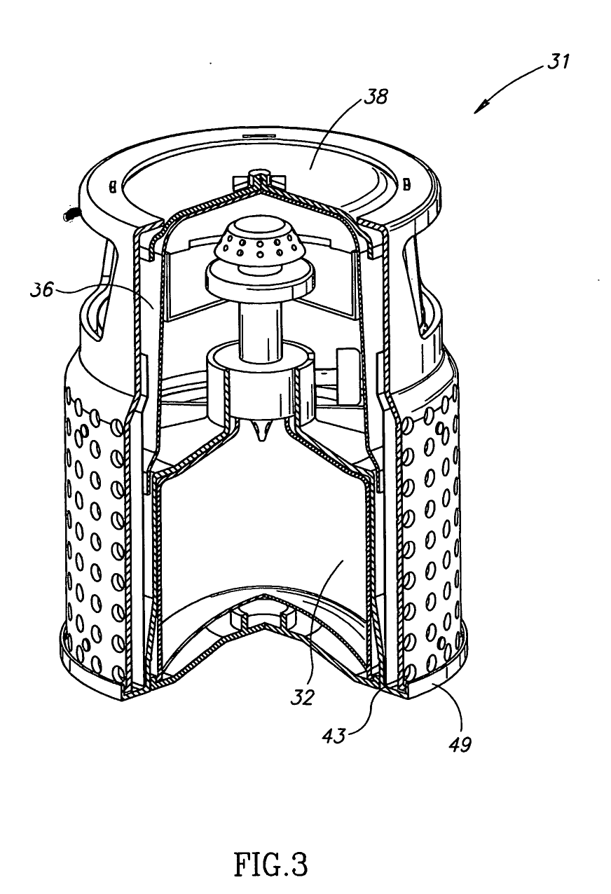

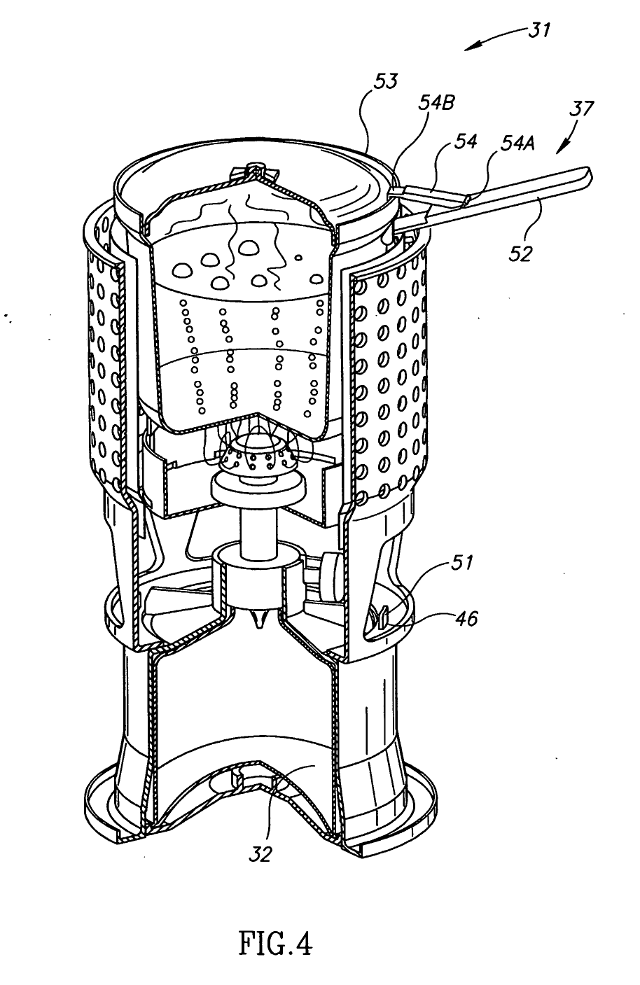

FIGS. 2-4 show a portable anti-spill single gas burner camp stove 31 similar to the camp stove 1 except that the former is intended to be used with a disposable combustible gas canister 32 (see FIGS. 3 and 4) and can be stored away as a compact nested item for convenient storage and carrying purposes, and is also capable of being used for general cooking purposes. The camp stove 31 includes a housing 33 with a base member 34 for securing the gas canister 32 therein. The camp stove 31 includes a coffeepot 36 having an integrally formed flip-up carrying handle 37 and a lid 38. Alternatively, the coffeepot 36 may have a discrete clip on carrying handle. The camp stove 31 also includes a removable invertible sleeve-like anti-spill windshield 39 with a windshield portion 41 similar to the windshield portion 19 and a ventilation portion 42 similar to the ventilation portion 21 except that the windshield portion 41 has an interference rim 43 and the ventilation portion 42 has a flange 44 with equidistanced slots 46. By virtue of this construction, the anti-spill windshield 39 may be removably secured on the housing 33 to assume either a storage position in which the anti-spill windshield 39 doubles as a casing for the housing 33 with the coffeepot 36 placed on the housing 33, and the lid 38 placed on the coffeepot's upward facing underside (see FIG. 3) or an anti-spill position during use of the camp stove 31 (see FIG. 4).

The housing 33 includes a conventional dish-like windshield 47 for protecting the gas burner 9 against wind without the anti-spill windshield 39 in place. The windshield 39 includes three rotatably mounted supports 48 rotatable between inwardly directed positions with the anti-spill windshield 39 in place and outwardly directed positions for supporting a saucepan, a frying pan, and the like, for general cooking purposes with the anti-spill windshield 39 removed. The housing 33 also includes a rim member 49 for interference fit receiving the interference rim 43 for removably securing the anti-spill windshield 39 in its storage position (see FIG. 3). The housing 33 includes bayonet fitments 51 for engaging the slots 46 for removably securing the anti-spill windshield 39 in its anti-spill position (see FIG. 4). The carrying handle 37 includes a handle member 52 pivoted to the coffeepot 36 towards its rim 53 and a securing member 54 with one end 54A pivoted to the handle member 52 and its free end 54B for clipping onto the coffeepot's rim 53 whereby the carrying handle 37 is selectively disposable from its stowed away position (see FIG. 2) during storage of the camp stove 31 (see FIG. 3) into its carrying position during use of the camp stove 31 (see FIG. 4).

While the invention has been described with respect to a limited number of embodiments, it will be appreciated that many variations, modifications, and other applications of the invention can be made within the scope of the appended claims.

1. A portable anti-spill single gas burner camp stove for use with a coffeepot having a carrying handle, the camp stove comprising a housing having a single gas burner for selectively heating the coffeepot placed thereover, and a sleeve-like anti-spill windshield for snugly receiving at least a major portion of the coffeepot therein on its downward sliding insertion thereinto.

2. The camp stove according to claim 1 wherein said anti-spill windshield includes a windshield portion accommodating said gas burner and said at least a major portion of the coffeepot therein on its downward sliding insertion thereinto, and a near completely open ventilation portion for preventing downward suction of said gas burner's flame during use of the camp stove.

3. The camp stove according to either claim 1 or 2 wherein said anti-spill windshield is made from a heavy duty heat resistant plastic material and includes a metal lining.

4. The camp stove according to any one of claims 1 to 3 wherein said anti-spill windshield is provided with a carrying handle.

5. The camp stove according to any one of claims 1 to 4 wherein said anti-spill windshield is removably mounted on said housing and securable thereon in an anti-spill position during use of the camp stove and an inverted position during storage of the camp stove.

6. The camp stove according to claim 5 wherein said anti-spill windshield accommodates the coffeepot placed upside down on said housing during storage of the camp stove.

7. The camp stove according to claim 6 wherein the coffeepot includes a removable lid and said anti-spill windshield accommodates said lid placed on the upward facing underside of the coffeepot in said upside down position during storage of the camp stove.

8. The camp stove according to any one of claims 5 to 7 wherein the coffeepot includes an integrally formed flip-up carrying handle selectively disposable between a carrying position during use of the camp stove and a stowed away position during storage of the camp stove.
